(19) United States
(12) Patent Application Publication
(10) Pub. No.: US 2019/0009490 A1
(43) Pub. Date: Jan. 10, 2019

(54) METHOD AND APPARATUS FOR FORMING A PACKAGE BOX

(71) Applicant: OY JOPAMAC AB, Forssa (FI)

(72) Inventor: Jouni SUOKAS, Tammela (FI)

(73) Assignee: Oy Jopamac AB, Forssa (FI)

(21) Appl. No.: 16/060,616

(22) PCT Filed: Dec. 23, 2016
(86) PCT No.: PCT/FI2016/050919

§ 371 Date: Jun. 8, 2018

(30) Foreign Application Priority Data
Dec. 23, 2015 (FI) 20156011

(51) Int. Cl. B31B 50/00; B31B 50/28; B31B 50/06; B31B 50/25; B31B 50/20; B31B 50/81; B31B 50/88; B31B 50/72

(52) U.S. Cl. CPC B31B 50/006; B31B 50/28; B31B 50/005; B31B 50/066; B31B 2105/0022; B31B 50/20; B31B 50/8127; B31B 50/88; B31B 50/722; B31B 50/25

(57) ABSTRACT

The object of the disclosure is a method and an apparatus for forming a package box. In the first phase of the method, a box blank is placed at the start of the box-forming process and is brought to the conveying motion. In the next phase, the markings of the package boxes are formed. In the third phase, the box blank is folded around an inner support and its ends are fastened together into one tubular blank component. In the fourth phase, a base panel is affixed to the box frames. In a fifth phase, the package boxes are transferred for further processing according to the order. The different phases of the method also comprise at least the following actions to be taken on the basis of online data coming from the picking system: In the first phase, a box blank is selected, which forms a box frame for one or more package boxes, the width of which box frame corresponds most suitably to the online data; or a box blank is cut to the correct width according to online data. In the next phase, the necessary fold lines are formed in the box blank on the basis of online data and the necessary markings are made on each box frame to be formed from a box blank. In the third phase, the box blank is cut by means of the cutting device on the basis of online data into box frames of the height of the package boxes to be formed.

The object of the present invention is a method as specified in the preamble of claim 1 and an apparatus as specified in the preamble of claim 9 for forming a package box.

The method and apparatus according to the invention, hereinafter more briefly the solution according to the invention, relates to a package box mechanically fabricated, preferably from recyclable fiber material, for each specific order on the basis of online data, e.g. in conjunction with shipping departments. In this case one preferred option for material is corrugated board and/or some other suitable recyclable fiber material, which is delivered essentially without pre-processing to package box forming directly e.g. from a corrugated board mill.

According to what is known in the art, package boxes are generally fabricated from box blanks, the first and last side of which are glued together at their vertical edge, and which blanks also comprise flaps forming a base and a lid. In these solutions e.g. a corrugated board mill produces in the first processing phase the raw material for boxes, which is delivered to a second processing phase, in which box blanks are fabricated from the corrugated board by cutting the raw material received into panels of the right size and shape, and by providing the box blanks with the necessary fold lines and by folding the blanks into the shape of a box as well as by gluing them into semifinished boxes, which are finally flattened and stacked into bundles one on top of another and are delivered as bundles to the third processing phase, in other words to e.g. the final forming of a package box in the product picking and shipping stage.

A problem in these solutions is that an extra raw-material processing phase is needed for fabricating a finished package box, which incurs additional costs resulting from the fabricating, packing and transportation of the flattened box blanks as well as from opening the package bundles before the final forming phase of the package boxes. Another problem is that the flattening, bundling and transportation of a box blank have a detrimental effect on the quality of the final box, causing inaccuracies in the dimensions of the box and small distortions. Among other things, the angles of an assembled finished box are not necessarily exact right angles, and this reduces the available packaging space.

One of the most widely used package boxes according to prior art is the four-flap regular slotted container, known by the code FEFCO 0201. A problem in this solution is that in a pre-assembled package box there are two layers of corrugated board one on top of another in a large part of the lid structure and base structure. In some cases, such as in boxes according to code FEFCO 0203, there are even four layers of corrugated board one on top of another. More corrugated board is needed as a consequence of this overlapping of material, which makes a package box more expensive and at the same time also reduces the useful volume of the inside space of the box. Another drawback is the inflexibility of prior art in fabricating in an optimized manner package boxes that are of exactly the correct height with regard to the product or product batch to be packed, and this inflexibility raises packing material costs and also shipping costs.

The aim of the present invention is to eliminate the aforementioned drawbacks and to provide an inexpensive, reliable, fast, flexible and cost-efficient method and apparatus for forming a package box. In addition, one aim is to provide a method and an apparatus, with which package boxes can be fabricated with great dimensional accuracy, in which boxes it is possible to minimize the wasted space, and the size of the package boxes is adapted to be precisely the size required by the products to be packed in them. Yet another aim is to provide a method and an apparatus with which package boxes can be formed having a minimum amount of overlapping material layers, or none at all, taking up expensive package space. The method according to the invention is characterized by what is disclosed in the characterization part of claim 1. Likewise the apparatus according to the invention is characterized by what is disclosed in the characterization part of claim 9. Other embodiments of the invention are characterized by what is disclosed in the other claims.

The method and apparatus, or more briefly the solution, according to the invention is provided with means for receiving order-specific data, by the aid of which means continuous order data and/or control data, i.e. online data, is received from the picking system about the properties needed for forming package boxes, such as e.g. about the shape and height of the box, the printing of the outer surface, the number of tear strips and the identification data.

In the method according to the invention for forming a package box mechanically in a picking system, in the first phase a box blank is placed at the start of the box-forming process and is brought to the conveying motion, in the 25 second phase the markings of the package boxes are formed, in the third phase the box blank is folded around an inner support belonging to the apparatus and its ends are fastened together into a tubular blank component having the shape of the cross-section of the inner support, in the fourth phase a base panel is affixed to the box frames and in the fifth phase the package boxes are transferred for further processing according to the order. The different phases of the method also comprise at least the following actions to be taken on the basis of online data coming from the picking system: in the first phase a box blank is selected, which forms one or more box frames for a package box, the width of which box frame corresponds most suitably to the online data; or a box blank is cut scalably to the correct width according to online data. In the next phase the necessary fold lines are formed in the box blank on the basis of online data and the necessary markings are made on each box frame to be formed from a box blank. In the next phase by means of the cutting device the box blank is cut on the basis of online data into box frames of the height of the package boxes to be formed.

Large and essentially planar box blanks cut to size from panels of corrugated board that have not undergone intermediate processing are delivered to the first phase e.g. directly from a corrugated board mill. In the phases presented previously tear strips facilitating the opening of both the lid and a possible base, as well as individualized identification data associated with the package boxes, can also be mechanically affixed to the box blanks on the basis of online data.

The apparatus according to the invention preferably comprises at least a feeder line, a box-forming line and an output line, as well as a plurality of actuators. The apparatus is provided with means for selecting a box blank, which forms one or more box frames for a package box, the width of which box frame corresponds most suitably to the online data; or means for cutting a box blank to the correct width on the basis of online data. The apparatus is also provided with creasing means, which are arranged to crease the necessary fold lines in the box blank on the basis of online data, as well as with marking means, which are arranged to make the necessary markings on each box frame to be formed from the box blank. The apparatus is also provided with cutting means, which are arranged to cut a box blank on the basis of online data into box frames of the height of the package boxes to be formed.

One advantage, among others, of the method and apparatus according to the invention, more briefly described in other words as the solution according to the invention, is that one processing phase that incurs significant extra costs is removed in the fabrication of the final package box, in which phase box blanks are made from material blanks, and the box blanks are packed into bundles or stacks and transported to the package box fabrication process. Another advantage also is that the package boxes fabricated by means of the solution according to the invention optimize the inner volume of the box for the product or product batch to be packed because the boxes are geometrically of precise measurements and of sharp corners, and because a box is cut to precisely the correct height according to the height of the product to be packed, and because the base structure and lid structure can be made to be simple and using thinner and less expensive material than in the frame of the package. Optimizing the volume results in considerable savings in material costs as well as in shipping costs.

In the following the invention will be described in more detail by the aid of some examples of its embodiment with reference to the attached simplified drawings, wherein

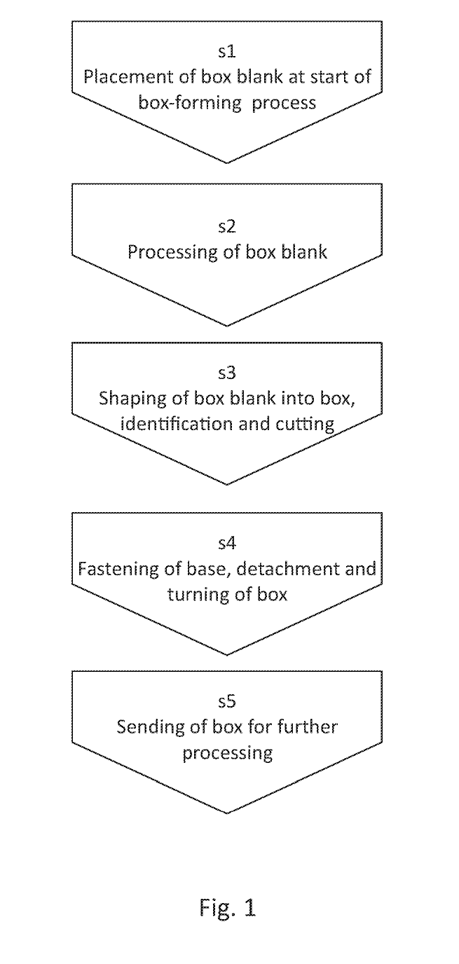

FIG. 1 presents one flow chart of the production process implemented by means of the method according to the invention for forming a package box from a box blank,

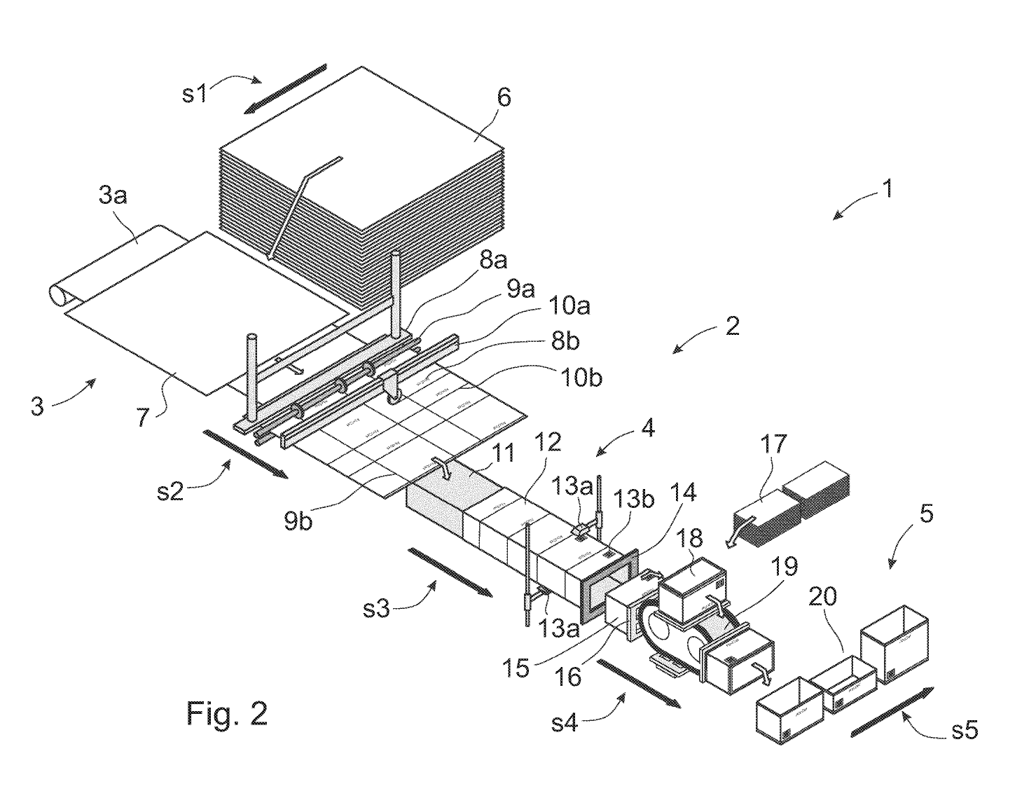

FIG. 2 presents a simplified view of one method and apparatus according to the invention, as seen obliquely from the side and from above, with which method and apparatus package boxes of a number of heights are fabricated for further processing in the process,

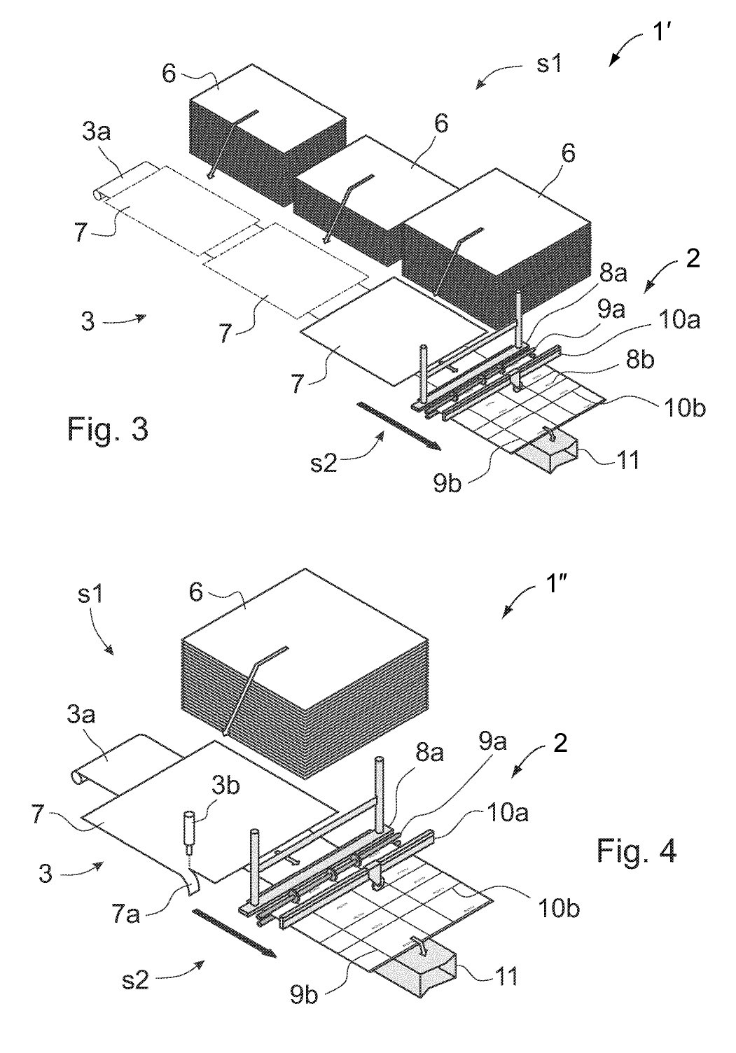

FIG. 3 presents a simplified view of the start end of another apparatus according to the invention, as seen obliquely from the side and from above, with which apparatus package boxes of a number of heights and of a number of cross-sectional sizes and shapes are fabricated for further processing in the process,

FIG. 4 presents a simplified view of the start end of a third apparatus according to the invention, as seen obliquely from the side and from above, with which apparatus package boxes of a number of heights and of a number of cross-sectional sizes and shapes are scalably fabricated for further processing in the process.

The method and apparatus according to the invention, i.e. more briefly the solution, comprise the phases s1-s5. For implementing phases s1-s3, the apparatus 1 is provided with means for receiving order-specific data, by the aid of which means continuous order data and/or control data, i.e. online data, from the picking system about the properties needed for forming package boxes 20, such as e.g. about the height of the box, the shape, the printing of the outer surface, the number of tear strips and identification data.

FIG. 1 presents a flow chart of the different phases s1-s5 of one method according to the invention and FIG. 2 presents one apparatus 1 according to the invention, with which the method phases according to the flow chart presented in FIG. 1 are implemented. The apparatus 1 is disposed e.g. in connection with or in the proximity of a picking warehouse and/or shipping department, so that each order-specific package box 20 needed each time is quickly formable on the basis of the online data and available for packaging use.

In the solution according to the invention the frame material for the package box 20 to be fabricated is delivered directly, without intermediate processing phases changing the shape or properties of frame material, from the mill manufacturing the frame material, e.g. from a corrugated board mill, to the start of the box-forming process, e.g. to the vicinity of the start end of the process line of the apparatus 1. In this case the frame material of the package boxes 20 to be fabricated is preferably e.g. box blanks 7, such as essentially straight corrugated board panels to a pre-specified size in one or more stacks 6. Box blanks 7 pre-cut to a specified size can come from the frame material manufacturer e.g. as blank cassettes, comprising a plurality of box blanks 7 stacked one on top of another, or stacked on a pallet.

In certain cases, the frame material can also be delivered in rolls, in which case in the starting phase of the box-forming process a box blank 7 of the correct size is first cut from the roll of material, after which the process is similar to the box-forming process started from a plate-shaped box blank 7.

In the first phase s1 of the method a box blank 7 cut to size, i.e. of the correct width and length, forming the box frame 15 of one or more package boxes 20, is placed with the selection means one at a time at the start of the box-forming process, on the conveyor 3a of the feeder line 3 of the apparatus 1, and the box blank 7 is brought to an essentially continuous conveying motion, in connection with which the short stops necessary to the process are made.

It is advantageous to fabricate, by means of an inner support 11 belonging to the apparatus 1, a number of package boxes 20 that are of a number of heights and similar cross-sectional shapes, and that are equally large in terms of the surface area of their bases, from one box blank 7 on the same apparatus assembly. The inner support 11 can also be replaceable or adjustable, in which case boxes of different cross-sectional shapes and/or of different sizes in terms of the surface area of their base can also be made with the same apparatus 1. By replacing the inner support 11, or by adjusting its shape and size, as well as by adjusting the other actuators of the apparatus 1 suitably, rectangular boxes of also other sizes can be made with the solution according to the invention, and so can boxes of a shape other than rectangular, e.g. polygonal or round boxes. In such a case the inner support 11 can, instead of being 4-edged in cross-sectional shape, have 5, 6, 7, 8 or even more edges, until it is almost round, or the inner support 11 can even be round or elliptical in cross-sectional shape. When making package boxes of different sizes and shapes, the number and distances of the fold lines 9b, i.e. creases, are adjusted by means of the fold line forming device 9a belonging to the apparatus 1, according to the shape of the package box 20 to be fabricated, and the base panel 18 and lid of the box are of corresponding shapes.

The actuators of the apparatus 1 according to the invention in the box-forming line 2 of the apparatus 1 are, inter alia, a printer device 8a, a device 9a for forming fold lines, a device 10a for affixing a tear strip as well as a device 4 for folding the sides of the package box, a printer device 13a for the label of a product or product batch to be packed, a cutting device 14 and a base placement device 19 provided with a mold 16.

In the next phase s2 of the method, the order-specific texts and FIG. 8b needed on the basis of online data for each package box 20 to be formed are printed by means of the printer device 8a directly onto the surface of the box blank 7. The vertical fold lines 9b of the box, which lines form the sharp and precise corners of the package box 20, are made with the device 9a for forming fold lines. After forming the fold lines 9b, tear strips 10b are affixed to the surface of the box blank 7 with the tear strip fastening device 10a. A tear strip 10b can be installed in this phase either for detaching only the lid of the package box 20 or for detaching both the lid and the base of the package box 20.

In phase s3 the box blank 7 pre-processed with the aforementioned actuators 8a, 9a, 10a is folded with the device 4 for folding the box sides according to the fold lines 9b around the inner support 11 into a tubular blank component 12 of rectangular cross-sectional shape, the edges of which component in the height direction of the boxes, said edges turning against each other, at both ends of the box blank 7 are fastened to each other e.g. by taping, for which purpose the box-forming line is provided with built-in actuators. Fastening a box blank 5 into a tubular blank component 12 is effected either at the point of the aforementioned edges, i.e. at the point of the corner of the box, or it can also be effected on the side of the package box, either in the center of the side or on one edge of the side, depending on the case. The joint can also be fastened either on one side of the wall or on both sides of the wall.

Each package box 20 being fabricated is identified, e.g. after forming the blank component 12, with a label printing device 13a, which affixes or prints onto the outer surface of the folded box blank 7 an individualized order-specific label 13b, e.g. a barcode label or RFID identifier. One or more labels 13b can be made on one package box 20 with the label printing device 13a. After this, on the basis of online data, the tubular blank component 12 is cut with the cutting device into a sleeve-shaped box frame 15 of the correct height for the specific order. The box frame 15 forms the load-bearing side walls and end walls of the package box 20.

In phase s4 the box frame 15 fabricated with the apparatus 1 is placed into precise shape in the mold 16 provided in the base placement device 19, and is turned 90 degrees into the base placement position in such a way that the base side of the box frame 15 opened into the mold points upwards. One base panel 18 is transferred from the base blank bundle 17 next to the base placement device 19 to on top of the edges of the box frame 15 that are pointing upwards, and the base panel 18 is fastened into place, forming the base of the package box 20, e.g. by taping. The package box 20 provided with a base panel 18 thus formed is turned upside-down after this with the base placement device 19 such that the open lidless part of the package box 20 is upwards.

In phase 5 the lidless package box 20 formed according to what is described above is transferred to the output line 5, by means of which the package boxes 20 are transported for further processing according to the order, for product packaging, closing of the box and shipping.

In the solution according to FIG. 3 a simplified view of the start end of another apparatus 1 according to the invention, is presented as seen obliquely from the side and from above. With this apparatus solution it is possible to form package boxes 20 of a number of heights and of a number of cross-sectional sizes and shapes for further processing in the process. The apparatus 1 according to FIG. 3 differs from the apparatus according to FIG. 2 only in that at the start end of the apparatus 1 is space for a number of frame material stacks 6, in which are box blanks 7 of different widths for package boxes that are of different cross-sectional sizes and different cross-sectional shapes. FIG. 3 presents three frame material stacks 6, of which the nearest to the start end of the box-forming line 2 is of box blanks 7 intended for package boxes of larger cross-sectional shape and the farthest from the start end of the box-forming line 2 is of box blanks 7 intended for package boxes of smaller cross-sectional shape The stack sequence can just as well also be the other way round, or the stack arrangement can otherwise be different, and there can also be a different number of stacks. Only one box blank 7 at a time is taken each time to the conveyor 3a of the feeder line 3 with the selection means, so that only the box blank 7 nearest the start end of the box-forming line 2 is described in FIG. 3 with a mainly unbroken line and the other two box blanks 7 on the conveyor 3a are described with dot-and-dash lines.

The phase s1 of the method is otherwise similar to that in the solution according to FIG. 2, but now, according to the size and shape of the package boxes to be formed, a box blank 7 that most suitably corresponds to the online data is taken by the aid of the selection means to the conveyor 3a of the feeder line 3 from the box blanks 7 of different widths. The other phases s2-s5 of the method are essentially similar to those in the solution according to FIG. 2.

In the solution according to FIG. 4 a simplified view of the start end of a third apparatus 1 according to the invention is presented, as seen obliquely from the side and from above. With this apparatus solution it is also possible to scalably form package boxes 20 of a number of heights and of a number of cross-sectional sizes and shapes for further processing in the process. The apparatus 1 according to FIG. 4 differs from the apparatus according to FIG. 2 only in that at the start end of the apparatus 1, in connection with the feeder line 3 or box-forming line 2, is a cutting device 3b, e.g. a laser cutting device, with which the box blank 7 is cut in the travel direction of the box blank 7 to correspond on the basis of online data to the cross-sectional size of the package box 20 to be formed. In this case with the cutting device 3b a strip 7a of the necessary width is cut from the width-wise dimension of the box blank 7, i.e. from the dimension that is at a right angle to the travel direction of the box blank 7, at the same time as the box blank 7 is conveyed onwards in the travel direction.

The phase s1 of the method is otherwise similar to that in the solution according to FIG. 2, but now a part 7a is cut off from the width of the box blank 7 before folding the box blank 7 into a tubular blank component 12. The other phases s2-s5 of the method are essentially similar to those in the solution according to FIG. 2.

The solutions according to FIGS. 3 and 4 and the replaceable and/or adjustable inner support 11 as well as the adjustable device 9a for forming fold lines enable the possibility of forming, by means of the apparatus 1, package boxes 20 of a number of different shapes and sizes in terms of their cross-section, without significant waste material.

This description of the solution according to the invention does not present the final stages of the packing process, such as packing the product into the package box 20 or closing the package box 20 with a lid. It can, however, be stated that it is advantageous to close a package box 20 with a lid that is similar in its dimensions and in its material to the base panel 18, in which case exactly the same methods and materials can be utilized for closing the package box 20 as are used in conjunction with the base panel 18 of the box.

As stated earlier, the lid and base panel 18 of a package box are advantageously fabricated e.g. from recyclable fiber material, particularly when the box frame 15 is also made of recyclable fiber material. In this way delivering a complete package box 20 to recycling is extremely easy. When a box is provided with tear strips 10b for detaching both the lid and the base of the box, the package box 20 is easily convertible after use into a bundle of recyclable fiber material taking up little space.

A box blank 7 can be fastened into a tubular blank component also by other methods than taping. In such a case the fastening can be carried out e.g. by gluing kraft paper to the outside or inside of a seam or by folding-gluing the edges together. Also the base panel 18 of a package box 20 can be affixed in some other way than by taping, e.g. the base panel 18 can be affixed by gluing kraft paper to the outside of a seam. If, on the other hand, the base panel 18 is provided with narrow flaps, the base panel 18 can be glued by its flaps to the outer surfaces of the box frame 15, instead of taping.

It is obvious to the person skilled in the art that the invention is not limited solely to the examples described above, but that it may be varied within the scope of the claims presented below. Thus, for example, some phases of the method can be in a different sequence than what is presented above and, in addition, some phases of the method can be absent and some phases of the method not presented can be included. Furthermore, some phases of the method can include more or fewer functions than what is presented above.

It is also obvious to the person skilled in the art that the package boxes made with the method can be different to what is presented above. The simplest and most common package box is, however, of a rectangular shape, which is described e.g. in FIG. 2.

It is further obvious to the person skilled in the art that the package boxes made with the method can be of some other material than recyclable fiber material. Thus, a package box can be fabricated from some other foldable material than corrugated board. A package box can be fabricated e.g. from different boards, cardboards or papers and also from woven material, plastic or metal, or from combinations of different materials. The side walls of a box and the lid and base can be of the same material as each other or can also be of a different material.

1. A method of mechanically forming a package box in a picking system, the method comprising:
in a first phase:
selecting a box blank to form a box frame for one or more package boxes, a width of the box frame corresponding to online data or the box blank cut to the width according to the online data;
placing the box blank at a start of a box-forming process; and
bringing the box blank to a conveying motion;
in a second phase:
forming fold lines in the box blank on the basis of the online data;
forming markings on each box frame to be formed from the box blank; and
forming markings of the package boxes;
in a third phase:
folding the box blank around an inner support of an apparatus;
fastening ends of the box blank together into a tubular blank component having the shape of a cross-section of the inner support; and
cutting, on the basis of the online data, the box blank into box frames having a height of the package boxes to be formed;
in a fourth phase, affixing a base panel to box frames; and
in a fifth phase, transferring the package boxes for further processing according to the order, wherein the different phases of the method also comprise at least the following actions to be taken on the basis of online data coming from the picking system:

2. The method of claim 1, wherein tear strips transverse to the travel direction of the box blank are affixed on the basis of online data to a planar surface of the box blank for opening one or more of a lid and a base of the package box.

3. The method of claim 1, wherein, before cutting the box blank into separate box frames on the basis of online data, one or more individualized labels are affixed or printed onto the surface of the box blank for each package box to be formed.

4. The method of claim 1, wherein the end edges of the box blank that have been folded around the inner support, the end edges being against each other, are fastened to each other with one or more of the following:
taping on the outer surface or an inner surface of a formed tubular blank component;
adhesive paper or glued kraft paper on the outer surface or the inner surface of the formed tubular blank component; and
cold gluing, hot gluing, or stapling partially overlapping edges.

5. The method of claim 1, wherein a base panel is affixed to the box frames in one or more of the following ways:
by taping;
with adhesive paper or with glued kraft paper; and
folding edge flaps of the base panel partly over side walls of the box frame and fastening the edge flaps to the outer surface of the side walls with cold gluing or hot gluing or by stapling.

6. The method of claim 1, according to wherein:
when making package boxes of different cross-sectional shapes and different cross-sectional sizes, the inner support is replaced to correspond to the size of the package box to be formed or the shape and size of the inner support is adjusted to correspond to the size of the package box to be formed; and
a device for forming fold lines is adjusted according to the size and shape of the package box to be formed.

7. The method of claim 1, according to wherein the box frame of the package box is formed from corrugated board, and wherein one or more of the base panel and the lid of the package box is formed from essentially straight corrugated board or from another recyclable fiber material.

8. The method of claim 1, wherein the box frame of the package box to be fabricated is formed from corrugated board, which is delivered directly from a corrugated board mill without any intermediate phases changing the shape or properties of the corrugated board.

9. An apparatus for forming a package box, the apparatus comprising:
a feeder line;
a box-forming line;
an output line;
a plurality of actuators;
a means for selecting a box blank that forms one or more box frames for a package box, the width of a box frame corresponding to online data, or a means for cutting the box blank to the width on the basis of the online data;
a creasing means arranged to crease fold lines in the box blank on the basis of the online data;
a marking means arranged to make markings on each box frame to be formed; and
a cutting means arranged to cut the box blank into the box frames of the height of the package boxes to be formed on the basis of the online data.

10. The apparatus of claim 9, wherein the box-forming line comprises:
actuators for affixing tear strips to a surface of a box blank;
additional actuators for affixing or for printing an order-specific identification label onto the surface of the box blank.

11. The apparatus of claim 9, wherein the box-forming line comprises
an inner support and actuators for folding a plate-shaped box blank around the inner support according to the fold lines into a tubular blank component; and
additional actuators for fastening turned edges of the tubular blank component against each other to fasten the turned edges to each other.

12. The apparatus of claim 9, further comprising:
a means for adjusting one or more of a cross-sectional size a cross-sectional shape of the inner support to correspond to a cross-sectional size and a cross-sectional shape of the package boxes to be formed;
a means for changing the inner support to correspond to the cross-sectional size and cross-sectional shape of the package boxes to be formed; and
a means for adjusting the actuators to correspond to the cross-sectional size and the cross-sectional shape of the package boxes to be formed.

13. The apparatus of claim 9, wherein according to the box-forming line comprises a cutting device for cutting a tubular blank component into the box frames on the basis of the online data of a picking system.

14. The apparatus of claim 9, wherein according to downstream of the cutting device the box-forming line has a base placement device including actuators for fixing the box frame into the base placement device in its precise cross-sectional shape, for turning the box frame base side upward, for affixing the base panel to the box frame, and for transferring the box frame from the base placement device to the output line.
